(19) United States
(12) Patent Application Publication
(10) Pub. No.: US 2019/0311438 A1
(43) Pub. Date: Oct. 10, 2019

(54) INSURANCE RISK EVALUATION SYSTEMS AND METHODS

(71) Applicant: TRAFFK, LLC, Los Angeles, CA (US)

(72) Inventors: Glenn T. Hibler, Malibu, CA (US); Jason B. Thomas, Dunn Loring, VA (US); Paul Ford, Vine Grove, KY (US)

(21) Appl. No.: 16/376,712

(22) Filed: Apr. 5, 2019

Related U.S. Application Data
(60) Provisional application No. 62/653,884, filed on Apr. 6, 2018.

(51) Int. Cl. G06Q 40/08; G06N 20/00; G06K 9/62; G06F 9/54

(52) U.S. Cl. CPC G06Q 40/08; G06F 9/54; G06K 9/6256; G06N 20/00

(57) ABSTRACT

An underwriting and risk management computing system is provided to utilize data science and machine learning to enable decision making and risk assessment. Predictive analytics utilizing expanded datasets can provide insightful data that is usable for insurance underwriting and provides actionable intelligence to stakeholders.

### CROSS-REFERENCE TO RELATED APPLICATION

This application claims the benefit of U.S. Provisional Application No. 62/653,884, entitled “ INSURANCE RISK EVALUATION SYSTEMS AND METHODS,” filed Apr. 6, 2018, the disclosure of which is hereby incorporated herein by reference in its entirety.

### BACKGROUND

Insurance underwriting involves the evaluation of risk and exposure of risk potential clients. Underwriting often includes determining a premium that needs to be charged to insure that risk. Insurance companies typically have their own set of underwriting guidelines to help determine whether or not the company should accept the risk. The information used to evaluate the risk of an applicant for insurance can depend on the type of coverage involved. However, insurance profitability is based on 30+-year-old underwriting guidelines and processes. Moreover, the insurance industry is highly fragmented and utilizes restricted and retrospective data sets, with little connectivity among underwriters, distributors and the clients they serve.

### BRIEF DESCRIPTION OF THE DRAWINGS

It is believed that certain embodiments will be better understood from the following description taken in conjunction with the accompanying drawings, in which like references indicate similar elements and in which:

FIG. 1 depicts an underwriting and risk management computing system in accordance with one non-limiting embodiment.

FIG. 2 depicts example processes of an example underwriting and risk management computing system in accordance with one non-limiting embodiment.

FIG. 3 depicts an example graphical segmentation index generated by an underwriting and risk management computing system.

FIG. 4 is an example process flow that can be implemented by an underwriting and risk management computing system.

### DETAILED DESCRIPTION

Various non-limiting embodiments of the present disclosure will be described to provide an overall understanding of the principles of the insurance underwriting risk evaluation systems and methods disclosed herein. One or more examples of these non-limiting embodiments are illustrated in the selected examples. The examples discussed herein are examples only and are provided to assist in the explanation of the apparatuses, devices, systems, and methods described herein. None of the features or components shown in the drawings or discussed below should be taken as mandatory for any specific implementation of any of these apparatuses, devices, systems, or methods unless specifically designated as mandatory.

In this disclosure, any identification of specific techniques, arrangements, etc. is either related to a specific example presented or is merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible.

It will be appreciated that modifications to the disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that, unless otherwise specified or required by context, any explicit or implicit ordering of steps performed in the execution of a method does not imply that those steps must be performed in the order presented but, instead, may be performed in a different order or in parallel.

Throughout this disclosure, references to components or modules generally refer to items that can be grouped logically together to perform a function or group of related functions. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software.

Systems and methods in accordance with the present disclosure can generally provide an underwriting and risk management platform enabling a variety of insurance products, services, and processes. In some embodiments, the underwriting and risk management platform is provisioned as a software-as-a-service (“SaaS”). The systems and methods disclosure herein can serve to modernize the insurance underwriting process with more accurate data insights and risk profiling that allows risk bearing companies to manage profitability, risk, market growth, cross lines sales, marketing, and compliance.

As described in more detail below, an underwriting and risk management platform in accordance with the present disclosure can enable organizations to deploy data mining, analytics and rules automation to manage risk, pricing, and utilization. Further, an underwriting and risk management platform in accordance with the present disclosure can assist insurance-related companies manage, utilize and expand their data to improve underwriting accuracy, manage risk, realize market growth and retention, and create data optimized solutions and offerings. The insurance-optimized risk management platform described herein can, in accordance with various embodiments, utilize machine learning and artificial intelligence (AI) to perform predictive analytics.

In accordance with one or more embodiments, the platform can generally facilitate, without limitation, one or more of the following operations/functionalities: data curation, enrichment and management; predictive analytics; a data information portal within a customer relationship management (CRM) platform; and/or a mobile workflow and communication technology.

For example, in accordance with the present disclosure, data can be curated, collected, integrated, and transacted on the underwriting and risk management platform, building unique datasets that give depth, granularity and detail to the risk and consumer profiles of insurance companies' membership. The underwriting and risk management platform can be HIPAA-compliant such that it complies with numerous technology assessments and security platform reviews.

The curated dataset utilized by the underwriting and risk management platform in accordance with the present disclosure can include a large number of unique data attributes spanning social determinants of health, consumer data, social media, and so forth, which can be combined with privatized insurance data. In accordance with various non-limiting embodiments, the systems and methods described herein can utilize data from a vast array of different sources, such as federal, state, and/or local datasets, datasets from various social media platform, geolocation based data collected by GPS units, WiFi access points, cell phone towers, internet usage data which can include cookies DNS requests, and/or browsing history, for example, as well as personal economic data. In some embodiments, over 4,000 unique data attributes are collected and leveraged by the underwriting and risk management platform. The data can be transformed by a underwriting and risk management platform in conjunction with carrier data to generate actionable, dynamic, multi-variant indexes utilizing machine learning and artificial intelligence. Predictive insurance-optimized risk modification indexes and insights can utilize the curated datasets and proprietary algorithms.

Moreover, the underwriting and risk management platform can apply data science, machine learning and AI processes to the combined datasets to predict cost, utilization, trends, and risk per line of business with high degrees of accuracy. In some embodiments, the predictions are over 85% accurate. In accordance with the various embodiments of the present disclosure, the underwriting and risk management platform utilizes proprietary algorithms developed through machine learning and artificial intelligence (AI) techniques. When coupled with historical claims data, the internal data sets can create projected outcomes with remarkable accuracy that users can use for risk assessment and pricing on particular books of business, among a wide array of other marketing and compliance functions. This granular level analysis of a population to be underwritten, with respect to risk and pricing, can have a direct and material positive effect on loss ratios and product profitability.

As described in more detail below, membership can be indexed or segmented into risk profiles to enable efficient and dynamic pricing, risk reduction and underwriting. The underwriting and risk management platform can assist in making data actionable, driving deeper understandings of client and/or consumer tendencies and decision characteristics on which action can be taken.

In accordance with some embodiments, the underwriting and risk management platform can apply a stack of algorithms and analytics that determine gaps in insurance best practices that can be addressed to realize improved claims outcomes and reduce risk exposure based on line of business, such as medical, workers compensation, disability, life, worksite solutions, Critical Illness and Accident.

In some embodiments, and described in more detail below, the underwriting and risk management platform can include a data information portal that serves as a main entry-point for insurers and employers to act upon the insurance related data and derived insights of their customers and employees in a manner compliant with HIPPA/PHI regulations. Data in the portal can be ingested from the client's feed, enriched with third party information, and insights added by machine learning and/or other proprietary algorithms. In accordance with various implementations, API microservice extensions can provided for various system integrations.

The underwriting and risk management platform can allow for interaction with a rich library of reports and dashboards that target data from the groups all the way down to an individual member. Users can create their own custom report that builds upon their annotated dataset. While the data information portal and the reporting platform provide ways to consume data, advanced integration scenarios can be provided through APIs. For example, an IT team can consume the enhanced datasets using their own tools and they can integrate their existing system to retrieve information, such as a group's risk score, directly on their underwriting screens or to access data to guide an individual's product selection through their customer service terminals.

The underwriting and risk management platform can have a CRM that allows users to browse through or search for data on specific members to see their historical and derived data for a 360-degree view of each end-customer. Users can see this same information for entities like pharmacies and medical providers who service members, as well as demographic details and other predictive indicators of specific members. Users can create data-driven campaigns to send recurring communications to cohorts or segments of members. These communications can be targeted by selecting a region on a report or creating some other custom formula. The data information portal can allow authorized users to theme the portal, add users, create permissions, and can also act as the clearing house to configure other applications, such as a member mobile application or a web-based member application, for example.

A member application associated with the underwriting and risk management platform can serve as a means for members to view critical data related to their insurance in real time. This member application can be made available in various online stores with the name and branding of the employer or insurance agency. Insurance cards and non-sensitive data can be stored encrypted on a smartphone or other mobile networked device, such as a tablet, and accessible even when the device is not connected to a network, thereby allowing members to see the f information for themselves and, when authorized, their family members. Various functionalities can be provided through the member mobile application such as telemedicine, insurance card presentation, plan information, claim/spend information, and key contact information.

Generally, the underwriting and risk management platform can utilize data from a curated database to provide predictive analytics usable for customer acquisition. The curated data can include alternative insurance data points, which can include 4,000+ private and public data points. Data in the curated database can include demographic data, social determinants of health data, economic data, health data, telematics data, internet-of-things (i.e, wearables) data, research data, cookies, benchmarks and indexes, for example, which are curated and integrated into specialized data feeds to answer practically any insurance question.

In accordance with the present disclosure, predictive analytics can be utilized to perform risk analyses, indexing, consumer segmentation, profiling, and risk assessment. These analyses when combined with the curated database, can predict future claims for its clients. In some embodiments, such predictions are more than 85% accurate. Such analytics can be leveraged for direct-to-consumer and agency sales to increase the level of engagement with existing and potential clients while reducing the cost of client acquisition.

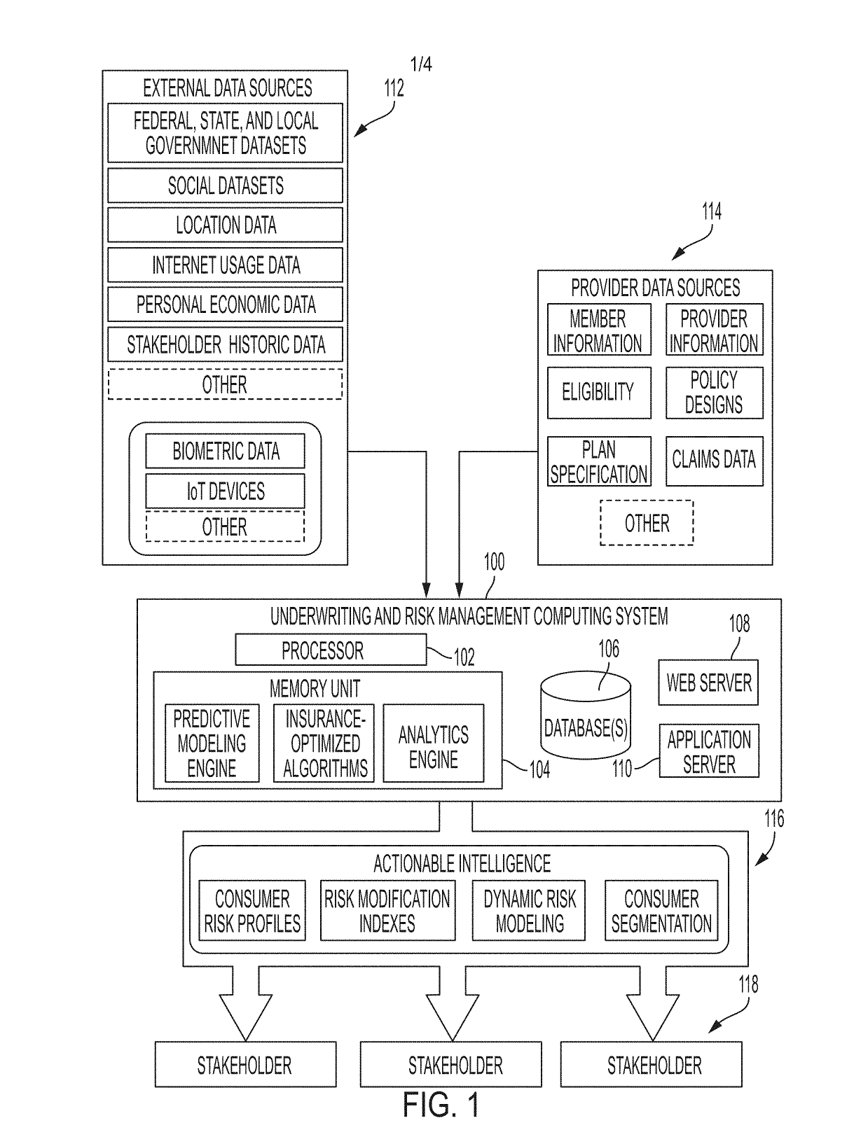

Referring now to FIG. 1, an example underwriting and risk management platform is schematically depicted as an underwriting and risk management computing system 100. The underwriting and risk management computing system 100 may be embodied as any type of server or computing device or computer devices that are capable of processing, communicating, storing, maintaining, and transferring data. For example, the underwriting and risk management computing system 100 may be embodied as a server, a microcomputer, a minicomputer, a mainframe, a desktop computer, a laptop computer, a mobile computing device, a handheld computer, a smart phone, a tablet computer, a personal digital assistant, a telephony device, a custom chip, an embedded processing device, or other computing device and/or suitable programmable device. In some embodiments, the underwriting and risk management computing system 100 may be embodied as a computing device integrated with other systems or sub systems.

In the illustrative embodiment of FIG. 1, the underwriting and risk management computing system 100 includes a processor 102 and a memory unit 104. Data used by the underwriting and risk management computing system 100 can be from various data sources and stored in one or more databases 106. The data stored in the database 106 can be stored in a non-volatile computer memory, such as a hard disk drive, a read only memory (e.g., a ROM IC), or other types of non-volatile memory. In some embodiments, the database 106 can be stored on a remote electronic computer system, such as cloud-based storage, for example. As is to be appreciated, a variety of other databases or other types of memory storage structures can be utilized or otherwise associated with the underwriting and risk management computing system 100. As such, the data sources utilized by the underwriting and risk management computing system 100 may be embodied as any type of device or devices configured for short-term or long-term storage of data such as, for example, memory devices and circuits, memory cards, hard disk drives, solid-state drives, or other data storage devices. For example, in some embodiments, the data sources include storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or Blu-Ray disk, and so forth. Storage media such as flash drives, solid state hard drives, redundant array of individual disks (RAID), virtual drives, networked drives and other memory means including storage media on the processor 102 or the memory unit 104, are also contemplated as storage devices. It should be appreciated that such memory can be internal or external with respect to operation of the disclosed embodiments. It should also be appreciated that certain portions of the processes described herein can be performed using instructions stored on a computer-readable medium or media that direct or otherwise instruct a computer system to perform the process steps. Non-transitory computer-readable media, as used herein, comprises all computer-readable media except for transitory, propagating signals.

The underwriting and risk management computing system 100 can include several computer servers and databases. For example, the underwriting and risk management computing system 100 can include one or more web servers 108, application servers 110, and/or any other type of servers. For convenience, only one web server 108 and one application server 110 are shown in FIG. 1, although it should be recognized that the disclosure is not so limited. The servers 108, 110 can comprise processors (e.g., CPUs), memory units (e.g., RAM, ROM), non-volatile storage systems (e.g., hard disk drive systems), etc. The servers 108, 110 can utilize operating systems, such as Solaris, Linux, or Windows Server operating systems, for example.

The web server 108 can provide a graphical web user interface through which various users of the system, such as stakeholders 118, can interact with the underwriting and risk management computing system 100. The web server 108 can accept requests, such as HTTP requests, from clients and serve the client's responses, such as HTTP responses, along with optional data content, such as web pages (e.g., HTML documents) and linked objects (such as images, video, and so forth). The application server 110 can provide a user interface for users who do not communicate with the underwriting and risk management computing system 100 using a web browser. Such users can have special software installed on computing devices that allows them to communicate with the application server 110 via a communications network.

Of course, the underwriting and risk management computing system 100 may include other or additional components, such as those commonly found in a server, SaaS implementation, and/or a computer (e.g., various input/output devices). Additionally, in some embodiments, one or more of the illustrative components may be incorporated in, or otherwise form a portion of, another component. For example, the memory unit 104, or portions thereof, may be incorporated in the processor 102 in some embodiments. Furthermore, it should be appreciated that the underwriting and risk management computing system 100 may include other components, sub-components, and devices commonly found in a computer and/or computing device, which are not illustrated in FIG. 1 for clarity of the description.

The processor 102 may be embodied as any type of processor capable of performing the functions described herein. For example, the processor 102 may be embodied as a single or multi-core processor, a digital signal processor, microcontroller, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or other processor or processing/controlling circuit or controller.

The memory unit 104 may be embodied as any type of volatile or non-volatile memory or data storage capable of performing the functions described herein. For example, the memory unit 104 may be embodied as read only memory (ROM), random access memory (RAM), cache memory associated with the processor 102, or other memories such as dynamic RAM (DRAM), static ram (SRAM), programmable ROM (PROM), electrically erasable PROM (EEPROM), flash memory, a removable memory card or disk, a solid state drive, and so forth. In operation, the memory unit 104 may store various data and software used during operation of the underwriting and risk management computing system 100 such as operating systems, applications, programs, libraries, and drivers. Further, the memory unit 104 may store various data and software associated with a predictive modeling engine, insurance-optimized algorithms, as well as an analytics engine that can be utilized by the underwriting and risk management computing system 100 in accordance with the present disclosure.

The underwriting and risk management computing system 100 can utilize data from a variety of data sources, schematically illustrated as external data sources 112 and provider data sources 114. While FIG. 1 schematically depicts non-limiting examples of external data sources 112, it is to be appreciated that various embodiments may use data from a variety of different data sources without departing from the scope of the present disclosure. In some embodiments, the underwriting and risk management computing system 100 utilizes data from over 1,000, 2000, or even 4,000 different data sources. In any event, FIG. 1 illustrates that example external data sources 112 can include federal, state, and local government datasets. Additionally or alternatively, external data sources 112 can include sources that provide social datasets, such as data related to FACEBOOK, TWITTER, dating websites, and so forth. Additionally or alternatively, external data sources 112 can include location data collected from various sources, such as a GPS, cell phone towers, and so forth. Additionally or alternatively, external data sources 112 can include internet usage data, which may be in the form of internet cookies, DNS request, browsing history, and so forth. Additionally or alternatively, external data sources 112 can include personal economic data, such as a credit information, charity and political donation history, and so forth. Additionally or alternatively, external data sources 112 can include stakeholder historic data, such as historical claim information from the client and their existing database. Such data can be collected or otherwise transferred to the underwriting and risk management computing system 100, such as API calls, flat files, FTP transfers, and so forth.

FIG. 1 also illustrates that data associated with specific individuals can be fed into the underwriting and risk management computing system 100. Non-limiting examples of such data includes biometric data, data collected from wearable or other Internet-of-Things devices, such as data collected by a FITBIT or APPLE Watch. Additionally or alternatively, other data collected can be provided through a mobile application that provides data collected from the associated mobile device. Additionally or alternatively, data can be collected from other electronic devices, such as OBD2 scanners, glucose readers, and so forth.

As shown in FIG. 1, a variety of datasets can be received from an insurance provider, as shown by provider data sources 114. Non-limiting examples of provider data sources 114 are shown to include member information, provider information, eligibility data, policy designs, plan specifications, and claim data, among a wide variety of other types of data that can be collected.

Data received from the various data sources 112, 114 can be stored in the one or more databases 106. Thus, the data stored in the one or more databases 106 can include, for example, Social Determinants of Health (SDoH) data which is socio-economic data with highly correlative data and metrics related to zip code, county and state data filtered by age, gender and location at individual or group cohort level. Examples include food accessibility scores, healthcare access, health prevalence data, etc. Additionally or alternatively, the data stored in the one or more databases 106 can include medical science data that includes highly correlative risk indicators and indexes derived from medical research and approved by FDA and other regulatory and institutional stakeholders. Additionally or alternatively, the data stored in the one or more databases 106 can include health data, which can include claims data for medical, pharmacy and lab data at the individual and group cohort level. Such data can be based on real-time data availability. Additionally or alternatively, the data stored in the one or more databases 106 can include economic indicators at the individual, household and business entity level with attributions to income, disposable income, demographic status, etc. Additionally or alternatively, the data stored in the one or more databases 106 can include consumer demographics with data points including individual, household, and/or business entity interest, preferences, status, household composition, workforce, etc. Additionally or alternatively, the data stored in the one or more databases 106 can include telematics data, which is generally movement data tied to mobile devices that include location based data, movement, dwell time, etc. to pixilate the view on behavior, risk and intersections with multiple location matching and risk identification. Additionally or alternatively, the data stored in the one or more databases 106 can include Internet of Things (IoT)/Connected Devices. Such devices can connect to medical and health devices including scales, Fitbit, health apps, glucometers and other enabled devices.

Subsequent to the collection, integration, and analysis of the data, the underwriting and risk management computing system 100 can transform the data into actionable intelligence 116. While the format of the actionable intelligence 116 can vary, examples of actionable intelligence 116 includes the generation of consumer risk profiles, risk modification indexes, dynamic risk modeling, and consumer segmentation. Additional detail regarding example actionable intelligence 116 is provided below.

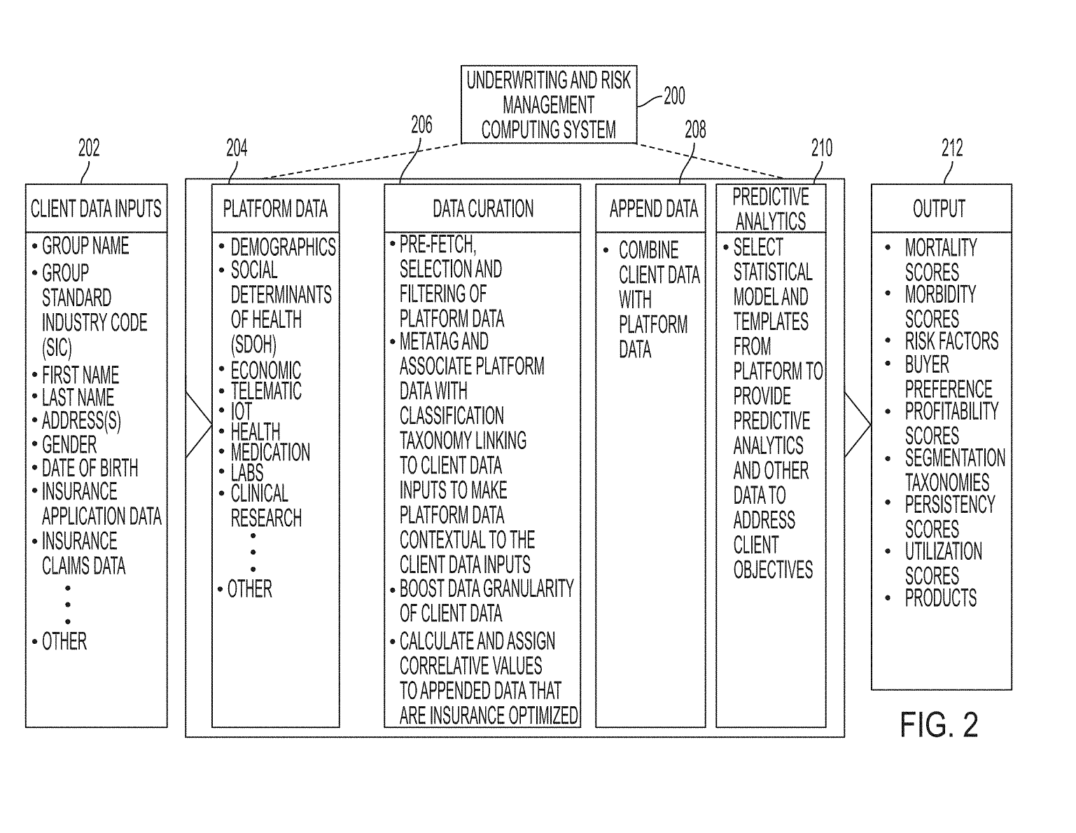

FIG. 2 depicts example processes of an example underwriting and risk management computing system 200. The underwriting and risk management computing system 200 can be similar to the underwriting and risk management computing system 100 depicted in FIG. 1, for example. As shown, client data inputs 202 can be ingested into the underwriting and risk management computing system 200. While the specific client data inputs 202 for a plurality of insurance consumers can vary, example data inputs are schematically shown in FIG. 2 to include group name, group standard industry code, first name, last name, address(s), gender, date of birth, insurance application data, and insurance claims data. Such client data inputs 202 can be collected from, for instance, the provider data sources 114 of FIG. 1. The underwriting and risk management computing system 200 can further utilize a variety of additional data points, which are schematically illustrated as platform data 204. While the specific platform data 204 can vary, example platform data schematically shown in FIG. 2 includes demographics, social determinants of health, economic data, telematics data, internet-of-things data, health data, medication data, lab data, and clinical research data. The platform data 204 can be sourced from a variety of different data sources, such as research organizations and one or more third party databases. The platform data 204 can be collected from, for instance, the external data sources 112 of FIG. 1.

The underwriting and risk management computing system 200 can perform various data curation processes 206 prior to performing various analytical processes. For instance, example data curation processes can include a pre-fetch, selection and filtering of the platform data 204. The underwriting and risk management computing system 200 can utilize metatags to associate platform data with a classification taxonomy linking the client data inputs 202 thereby making the platform data 204 contextual to the client data inputs 202. The granularity of the client data inputs 202 can then be boosted and the correlative values can be calculated and assigned.

An append data process 208 can be executed to combine the client data with the platform data such that predictive analytics 210 can be performed on the appended data. As part of the predictive analytics 210, statistical models and templates can be selected by the underwriting and risk management computing system 200 to provide predictive analytics and other data to address client objectives. Example models include Cox-Regression models, generalized linear models, and tree based models. As shown in FIG. 2, the underwriting and risk management computing system 200 can generate various outputs 212. While the outputs 212 can vary per client, in some embodiments the outputs 212 can include, without limitation, mortality scores, morbidity scores, risk factors, buyer preferences, profitability scores, segmentation taxonomies, persistency scores, utilization scores, as well as various insurance-related products. It is to be appreciated that the various processes 202, 204, 206, 208, 210, and 212 can be performed in various orders, as well as concurrently or serially. Further, it is to be appreciated, that the outputs 212 can be used by one or more of the processes 204, 206, 208 and 210 as part of a feedback loop, for example.

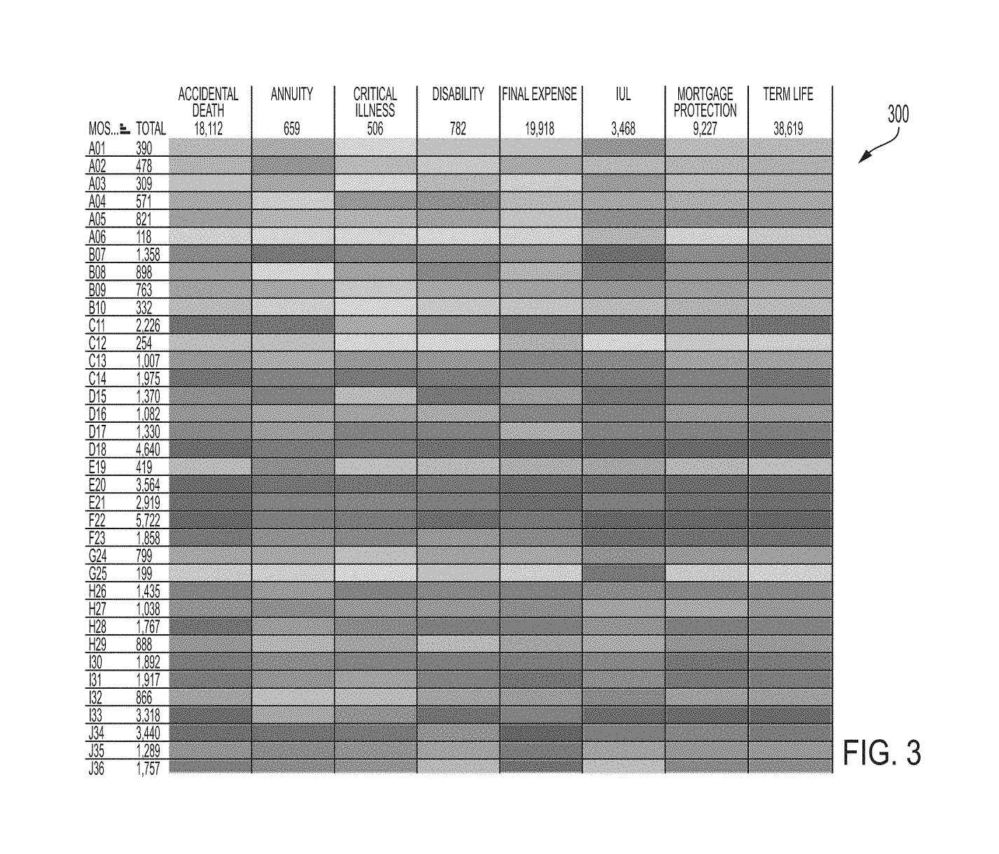

Referring now to FIG. 3, an example graphical segmentation index 300 is schematically depicted, which is one example output of an underwriting and risk management computing system in accordance with the present disclosure While the graphical segmentation index 300 is depicted as a color-coded chart, with relative segmentation risk being conveyed via color, it is to be readily appreciated that a variety of different techniques can used by the underwriting and risk management computing system to convey information.

The graphical segmentation index 300 depicts segmentation cohorts on each row (shown as A01, A02, etc.). The graphical segmentation index 300 also indicates the number of individuals assigned to that segmentation cohort. The individuals can be, for example, policy holders for a particular carrier. Segmentation cohort A01 is shown to include 390 individuals, A02 is shown to include 478 individuals, and so forth. By way of example, segmentation cohort A01 may be young insureds that live in urban areas and do not own their own home.

In this example, each column is representative of a different policy type, shown as accidental death, annuity, critical illness, disability, final expense, universal life, mortgage protection, and term life. The relative darkness of the individual cells in this particular embodiment can be used to convey certain information. For instance, darker cells may indicate that purchasing behavior, risk, and so forth. Thus, as segmentation cohorts E20, E21, and F22 all have relatively dark cells, it may indicate that individuals in that group typically pursue extensive insurance coverage, across a variety of policy types. In comparison, segmentation cohorts A01 have light colored cells, indicating those individuals do not typical purchase extensive insurance coverage. Using this insight, a carrier may decide to target marketing expenditure to the individuals of segmentation cohorts E20, E21, and F22, as opposed to simply marketing to their entire policy holder population, in order to achieve improved return on investment. It is to be appreciated that carriers, or other users, can utilize the graphical segmentation index 300, or other types of outputs, for a wide array of applications related to profitability, risk, market growth, cross lines sales, marketing, and compliance.

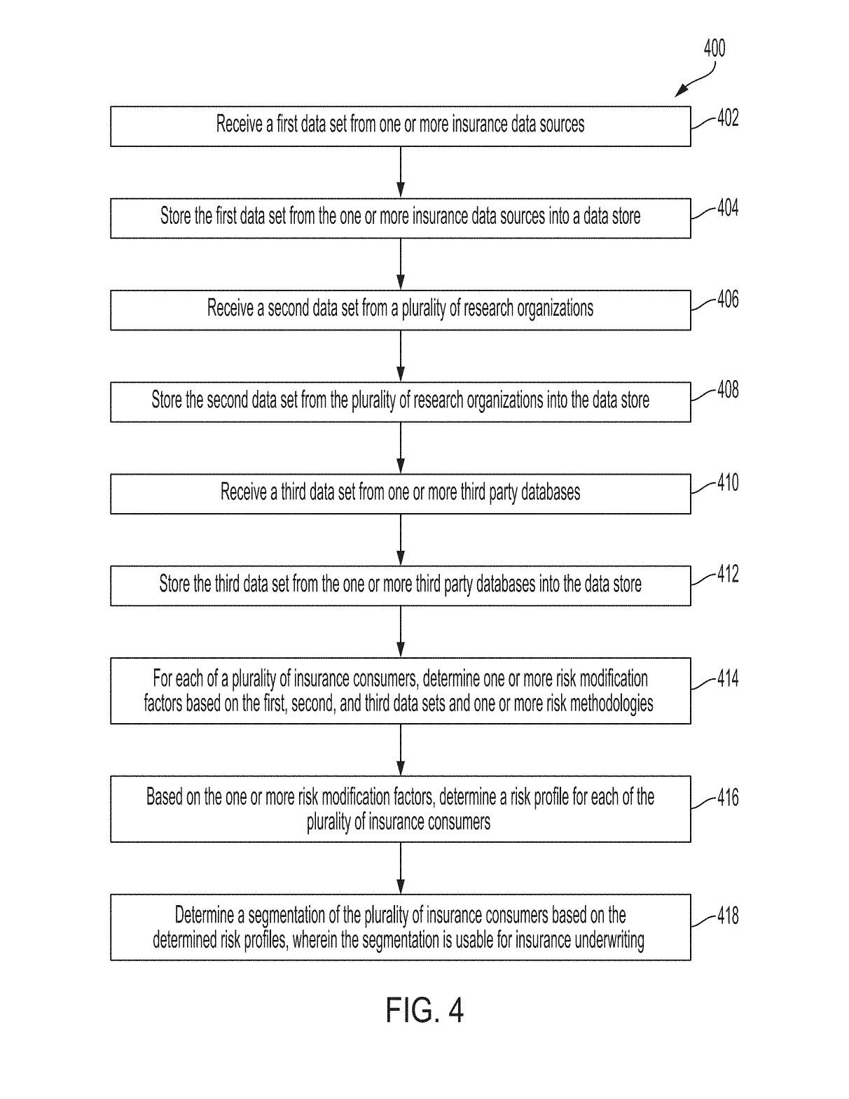

Referring now to FIG. 4, an example process flow 400 that can be implemented by a underwriting and risk management computing system is shown. While the process flow 400 shows example steps, it is to be appreciated that such must be performed in the order presented but, instead, may be performed in a different order or in parallel. At 402, a first data set is received from one or more insurance data sources. The first data set can comprise insurance claims data collected from one or more types of insurance offerings. The first data set can include data from each of a plurality of insurance consumers. Such first data set can be similar, for example, the provider data sources 114 of FIG. 1. At 404, the first data set from the one or more insurance data sources is stored into a data store. At 406, a second data set is received from a plurality of research organizations. At 408, the second data set from the plurality of research organizations is stored into the data store. At 410, a third data set is received from one or more third party databases. At 412, the third data set from the one or more third party databases is stored into the data store. Thus, the second and third data sets can be from external data sources, such as the external data sources 112 shown in FIG. 1. At 414, for each of a plurality of insurance consumers, one or more risk modification factors is determined based on the first, second, and third data sets and one or more risk methodologies. At 416, based on the one or more risk modification factors, a risk profile is determined for each of the plurality of insurance consumers. At 418, a segmentation of the plurality of insurance consumers is determined based on the determined risk profiles, wherein the segmentation is usable for insurance underwriting. In some embodiments, the segmentation is conveyed to a user as a graphical segmentation index, similar to the graphical segmentation index 300 show in FIG. 3, for example.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused discussions would not facilitate a better understanding of the present invention, and therefore, a more detailed description of such elements is not provided herein.

These and other embodiments of the systems, apparatuses, devices, and methods can be used as would be recognized by those skilled in the art. The above descriptions of various systems, apparatuses, devices, and methods are intended to illustrate specific examples and describe certain ways of making and using the systems, apparatuses, devices, and methods disclosed and described here. These descriptions are neither intended to be nor should be taken as an exhaustive list of the possible ways in which these systems, apparatuses, devices, and methods can be made and used. A number of modifications, including substitutions between or among examples and variations among combinations can be made. Those modifications and variations should be apparent to those of ordinary skill in this area after having read this disclosure.

What is claimed is:

1. A computer system including a processor and a memory, the memory containing software instructions configuring the system to perform acts including:
receive a first data set from one or more insurance data sources, wherein the first data set comprises insurance claims data collected from one or more types of insurance offerings, wherein the first data set includes data from each of a plurality of insurance consumers;
store the first data set from the one or more insurance data sources into a data store;
receive a second data set from a plurality of research organizations;
store the second data set from the plurality of research organizations into the data store;
receive a third data set from one or more third party databases;
store the third data set from the one or more third party databases into the data store;
for each of the plurality of insurance consumers, determine one or more risk modification factors based on the first, second, and third data sets and one or more risk methodologies;
based on the one or more risk modification factors, determine a risk profile for each of the plurality of insurance consumers; and
determine a segmentation of the plurality of insurance consumers based on the determined risk profiles, wherein the segmentation is usable for insurance underwriting.

2. The computer system of claim 1, wherein any of the first, second, and third data sets comprises social determinants of health data.

3. The computer system of claim 2, wherein the social determinants of health data comprise data correlated to each of the plurality of insurance consumers by any of zip code data, county data, and state data, wherein the correlated data is filtered by any of age, gender, and location.

4. The computer system of claim 1, wherein any of the first, second, and third data sets comprises medical science data.

5. The computer system of claim 4, wherein the medical science data comprises data correlated to risk indicators derived from medical research.

6. The computer system of claim 1, wherein any of the first, second, and third data sets comprises telematics data, wherein the telematics data comprises geolocation data for one or more of the plurality of insurance consumers.

7. The computer system of claim 1, wherein any of the first, second, and third data sets comprises data collected from one or more wearable electronic monitoring devices.

8. The computer system of claim 1, wherein the software instructions further configure the system to perform acts including:
predict a future insurance claim for one or more of the plurality of insurance consumers.

9. The computer system of claim 1, wherein the segmentation comprises a plurality of groups, wherein each of the plurality of insurance consumers is affiliated with one the plurality of groups based on the risk profile of the insurance consumer.

10. The computer system of claim 1, wherein the software instructions further configure the system to perform acts including:
transmit the risk profiles to an insurance company over a communications network.

11. The computer system of claim 10, wherein the insurance company is a provider of insurance services for each of the plurality of insurance consumers.

12. The computer system of claim 1, wherein the software instructions further configure the system to perform acts including:
transmit the segmentation to an insurance company over a communications network.

13. The computer system of claim 12, wherein the insurance company is a provider of insurance services for each of the plurality of insurance consumers.

14. The computer system of claim 1, wherein the software instructions further configure the system to perform acts including:
perform predictive modeling based on the first, second, and third data sets; and
transmit the results of the predictive modeling to a recipient.

15. The computer system of claim 14, wherein the recipient is any of an insurance company and a financial institution.

16. The computer system of claim 1, wherein the segmentation comprises insurance pricing tiers.

17. The computer system of claim 1, wherein the one or more third party databases comprises an open source database accessible via an application programing interface.

18. The computer system of claim 1, wherein the one or more third party databases comprises a private database accessible via an application programing interface.

19. A computer-based method of insurance underwriting, comprising:
receiving, by an underwriting and risk management computing system, data inputs from an insurance carrier, wherein the data inputs comprises at least a first name, a last name, and an address of a plurality of insurance consumers;
appending, by the underwriting and risk management computing system, the data inputs received from the insurance carrier with a plurality of data points maintained by the underwriting and risk management computing system to generate an appended data set, wherein the plurality of data points are collected by the underwriting and risk management computing system from a plurality of different data sources, wherein the plurality of data points comprise social determinants of health data and demographic data;
applying, by the underwriting and risk management computing system, one or more data modeling processes to the appended data set to perform predictive analytics;
determining, by the underwriting and risk management computing system and based on the result of the one or more data modeling processes, probability scores for an occurrence of one or more insurance events for each of the insurance consumers; and
providing, by the underwriting and risk management computing system, the probability scores for the occurrence of the one or more insurance events for each of the insurance consumers to the insurance carrier.

20. The computer-based method of claim 19, wherein the data inputs received from the insurance carrier further comprise a gender and a date of birth of each of the plurality of insurance consumers.

21. The computer-based method of claim 20, wherein the plurality of data points collected by the underwriting and risk management computing system from the plurality of different data sources further comprise economic data.

22. The computer-based method of claim 21, wherein the plurality of data points collected by the underwriting and risk management computing system from the plurality of different data sources further comprise telematics data, wherein the telematics data comprises geolocation data for one or more of the plurality of insurance consumers.

22. The computer-based method of claim 22, wherein the plurality of data points collected by the underwriting and risk management computing system from the plurality of different data sources further comprises data collected from one or more wearable electronic monitoring devices.

23. A computer-based method of insurance underwriting, comprising:
receiving, by an underwriting and risk management computing system, data inputs from an insurance carrier, wherein the data inputs comprise at least a first name, a last name, and an address of a plurality of insurance consumers;
receiving, by the underwriting and risk management computing system from a plurality of different data sources, a plurality of data points, wherein the plurality of data points comprise social determinants of health data and demographic data;
appending, by the underwriting and risk management computing system, the data inputs received from the insurance carrier with the plurality of data points received by the underwriting and risk management computing system to generate an appended data set,
applying, by the underwriting and risk management computing system, one or more data modeling processes to the appended data set to determine a consumer risk profile for each of the plurality of insurance consumers;
segmenting, by the underwriting and risk management computing system, the plurality of insurance consumers based on the consumer risk profile of each of the plurality of insurance consumers; and
providing, by the underwriting and risk management computing system, the segmentation of the plurality of insurance consumers to the insurance carrier.

24. The computer-based method of claim 23, wherein the data inputs received from the insurance carrier further comprise a gender and a date of birth of each of the plurality of insurance consumers.

25. The computer-based method of dim 23, wherein the plurality of data points received by the underwriting and risk management computing system from the plurality of different data sources further comprise economic data.

26. The computer-based method of claim 25, wherein the plurality of data points received by the underwriting and risk management computing system from the plurality of different data sources further comprise telematics data, wherein the telematics data comprises geolocation data for one or more of the plurality of insurance consumers.

27. The computer-based method of claim 26, wherein the plurality of data points received by the underwriting and risk management computing system from the plurality of different data sources further comprise data collected from one or more wearable electronic monitoring devices.
